(19) United States
(12) Patent Application Publication
(10) Pub. No.: US 2016/0280883 A1
(43) Pub. Date: Sep. 29, 2016

(54) Polyamide Composition

(71) Applicant: Kingfa Scientific & Technological Co., LTD., Guangzhou (CN)

(72) Inventors: Yang Yan, Guangzhou (CN); Zheng Yiquan, Guangzhou (CN); He Jihun, Guangzhou (CN); Liang Huiqiang, Guangzhou (CN); Sun Donghai, Guangzhou (CN)

(21) Appl. No.: 15/050,959

(22) Filed: Feb. 23, 2016

(30) Foreign Application Priority Data
Mar. 26, 2015 (CN) 201510135976.4

(51) Int. Cl. C08K 3/22; C08K 5/00; C08K 5/3492

(52) U.S. Cl. CPC C08K 3/22; C08K 5/34924; C08K 5/0066; C08K 5/005; C08K 2003/2248; C08K 2003/2293; C08K 2003/2265

(57) ABSTRACT

The present invention discloses a polyamide composition, which comprises the following components: a. 30 wt %-99 wt % of a polyamide resin; b. 0.001 wt %-3 wt % of a metal element; and c. 0 wt %-69.5 wt % of an additive; a content of the metal element is preferably 0.005 wt %-1 wt %, more preferably 0.007 wt %-0.2 wt %; and the percentages by weight are all relative to a total weight of a, b, and c. The polyamide composition prepared by adopting the polyamide resin having a specific pH value and a specific relative viscosity and adding the metal element of a specific content, of the present invention can be applied to a molding decorative lamp, and compared with a flame-retardant polypropylene material of an existing molding decorative lamp, can significantly improve a coloring property, a color stability and a heat retention stability of the material, and is bright in colors and high in production yield.

### TECHNICAL FIELD

The present invention relates to the field of illuminating materials, is particularly suitable for a decorative lamp material, and more particularly relates to a polyamide composition.

### BACKGROUND

With social and economic development, and rise in living standard, people prefer to use some decorative lamp strings to make a festival atmosphere in festivals, particularly the spring festival, the Christmas festival and the like. A lamp holder product of a decorative lamp must generally satisfy requirements such as high hardness, high flame retardance, good transparency, high thermal deformation temperature, good transparency, high hardness and the like, and a material widely used in the market at present is flame-retardant PP. With development of the industry, technical barrier standards continually enhanced in the export market place greater demands on lamps, and <<Directive of a Framework for the Setting of Eco-design Requirement for Energy-using Products>> (EUP Directive) as a more private technical barrier requires that a product is comprehensively environmentally friendly in a design, which brings great trials to lighting companies. With an increase in design requirement, users' requirements for the appearance of the decorative lamp are increasingly higher, a long-term color stability is a basic requirement, furthermore, a requirement for being more lightweight and thin and more energy-saving is also a developing requirement for the decorative lamp products, which requires that the material is higher in hardness, excellent in heat-resisting property and higher in impact property, whereas the existing flame-retardant PP is gradually unable to satisfy increasingly improved requirements for properties.

A polyamide has excellent comprehensive properties, including mechanical property, heat resistance, abrasion resistance, chemical resistance and self-lubricating property, is low in frictional coefficient, and has a certain flame retardance and the like; and the polyamide may be used for a long time at a thermal deformation temperature of 150° C. due to its high heat resistance, and has an excellent electrical insulating property. The polyamide has high strength, low oxygen permeability and good gas harrier property. The polyamide is excellent in impact property at −35° C. due to excellent low temperature resistance. However, the polyamide is poor in coloring property and heat retention stability due to its structure.

Now, a test for end groups of polyamide resin has become a commonly used means in this industry, for representing various kinds of information such as a number-average molecular weight and extent of reaction of the polyamide. Although the end groups of the polyamide might influence a pH value of a solution, this is not the only important factor. A rigidity of different polyamide molecular chains, a concentration of an acylamino group, a second virial coefficient, a Huggins parameter, a θ solvent behavior and the like would impose a big influence on its pH value. Due to a combined effect of the above-described factors, the polyamides may differ greatly in pH values even if they are identical in components and monomer ratio, thereby causing differences in properties of the polyamides, and even compositions thereof.

Therefore, the polyamide composition prepared by adopting a polyamide resin having a specific pH value and a specific relative viscosity and adding a metal element of a specific content, of the present invention can significantly improve the coloring property, a color stability and the heat retention stability of the material, and this material is suitable for producing a molding decorative lamp, good in durability, good in coloring property, permanent in color retention, and high in production yield.

### SUMMARY OF THE INVENTION

To overcome disadvantages and shortcomings of the prior art, a primary object of the present invention is to provide a polyamide composition significantly improving a coloring property, a color stability and a heat retention stability.

Another object of the present invention is to provide a use of the above-described polyamide composition in a molding decorative lamp.

The present invention is accomplished by the following technical solution:

a polyamide composition, which comprises the following components:

a. 30 wt %-99 wt % of a polyamide resin;

b. 0.001 wt %-3 wt % of a metal element; and

c. 0-69.5 wt % of an additive;

a content of the metal element b is preferably 0.005 wt %-1 wt %, more preferably 0.007 wt %-0.2 wt %;

the percentages by weight are all relative to a total weight of a, b, and c.

A pH value of the polyamide resin in a phenol is less than 7;

the polyamide resin is selected from one or more of a unit AB formed of an aliphatic diacid and/or alicyclic diacid A of 4-20 carbon atoms, and an aliphatic diamine and/or alicyclic diamine B of 4-20 carbon atoms; a unit C formed of a lactam C of 4-20 carbon atoms; and a unit ABC formed of the aliphatic diacid and/or alicyclic diacid A of 4-20 carbon atoms, the aliphatic diamine and/or alicyclic diamine B of 4-20 carbon atoms and the lactam C of 4-20 carbon atoms;

a relative viscosity of the polyamide resin in a 98% concentrated sulfuric acid having a measuring concentration of the polyamide resin of 10 mg/ml is 2-3 at 25° C.

Preferably, the pH value of the polyamide resin in the phenol shows: 1 ≦pH ≦6; more preferably 2 ≦pH ≦4.

In the aliphatic diacid and/or alicyclic diacid A of 4-20 carbon atoms, the aliphatic diacid is selected from one or more of succinic acid, glutaric acid, adipic acid, suberic acid, azelaic acid, sebacic acid, undecanedioic acid, dodecanedioic acid, tridecanedioic acid, tetradecanedioic acid, pentadecanedioic acid, hexadecanedioic acid, and octadecanedioic acid; and the alicyclic diacid is selected from one or more of dimer acid, cis- and/or trans-cyclohexane-1,4-dicarboxylic acid, and cis- and/or trans-cyclohexane-1,3-dicarboxylic acid (CHDA);

in the aliphatic diamine and/or alicyclic diamine B of 4-20 carbon atoms, the aliphatic diamine is selected from one or more of 1,4-butane diamine, 1,5-pentane diamine, 1,6-hexane diamine, 1,8-octane diamine (OMDA), 1,9-nonane diamine (NMDA), 1,10-decane diamine, 2-methyl-1,8-octane diamine (MODA), 2,2,4-trimethyl hexamethylene diamine (TMHMD), 2,4,4-trimethyl hexamethylene diamine (TMHMD), 5-methyl-1,9-nonane diamine, 1,11-undecane diamine, 2-butyl-2-ethyl-1,5-pentane diamine, 1,12-dodecane diamine, 1,13-tridecane diamine, 1,14-tetradecane diamine, 1,16-hexadecane diamine, and 1,18-octadecane diamine; and the alicyclic diamine B is selected from one or more of cyclohexane diamine, 1,3-bis(amino-terminated methyl) cyclohexane (BAC), isophorone diamine, norbornane dimethylamine, 4,4′-diamino-terminated dicyclohexyl methane (PACM), 2,2-(4,4′-diamino-terminated dicyclohexyl) propane (PACP), and 3,3′-dimethyl-4,4′-diamino-terminated dicyclohexyl methane (MACM); and the lactam C of 4-20 carbon atoms is selected from one or more of caprolactam, undecanolactam, and dodecanolactam.

Preferably, the unit AB formed of the aliphatic diacid and/or alicyclic diacid A of 4-20 carbon atoms and the aliphatic diamine and/or alicyclic diamine B of 4-20 carbon atoms is selected from one or more of polyhexamethylene adipamide PA66, a polyhexamethylene sebacamide PA610, and polydecamethylene sebacamide PA1010; the unit C formed of the lactam C of 4-20 carbon atoms is selected from one or more of polycaprolactam PA6, polyundecanolactam PA11, and polydodecanolactam PA12; and the unit ABC formed of the aliphatic diacid and/or alicyclic diacid A of 4-20 carbon atoms, the aliphatic diamine and/or alicyclic diamine B of 4-20 carbon atoms and the lactam C of 4-20 carbon atoms is selected from adipic acid-hexane diamine-caprolactam copolymer PA66/6.

The metal element is derived from a metal compound, the metal compound is selected from one or more of a calcium compound, a magnesium compound, an iron compound, an aluminium compound, a sodium compound, a nickel compound, a bismuth compound, a copper compound, and a zinc compound; the calcium compound is selected from one or more of calcium carbonate, calcium oxide, calcium stearate, and calcium hydroxide; the magnesium compound is selected from one or more of magnesium oxide, magnesium hydroxide, and magnesium stearate; the iron compound is selected from one or more of iron oxide, iron hydroxide, and iron carbonate; the aluminium compound is selected from one or more of aluminium oxide, aluminium magnesium salt, aluminium hydroxide, and aluminium potassium sulfate; the sodium compound is selected from one or more of sodium oxide, sodium peroxide, sodium carbonate, and sodium bicarbonate; the nickel compound is selected from nickel titanate; the bismuth compound is selected from bismuth vanadate; the copper compound is selected from a copper salt, and a complex including copper oxide and copper; and the zinc compound is selected from zinc oxide.

The metal element preferably contains nickel.

The additive is selected from one or more of a fire retardant, an antioxidant, a light stabilizer, a heat stabilizer, an impact modifier, a nucleating agent, other polymers, a processing agent, a lubricant, an anti-static agent, a filler, and a colorant.

The fire retardant is a fire retardant or a composition of the fire retardant and a flame-retardant aid, and its content is 0.5 wt %-30 wt % based on the total weight of the polyamide composition; a flame-retardant effect becomes worse due to too low content of the fire retardant, and a mechanical property of the material is reduced due to too high content of the tire retardant.

Wherein, the fire retardant is a halogen-based fire retardant or a halogen-free fire retardant, preferably the halogen-free fire retardant; the halogen-based fire retardant includes but is not only limited to one or more of a brominated polystyrene, a brominated polyphenyl ether, a brominated bisphenol A type epoxy resin, a brominated styrene-maleic anhydride copolymer, a brominated epoxy resin, a brominated phenyoxy resin, decabromodiphenyl ether, decabromodiphenyl, a brominated polycarbonate, perbromotricyclopcntadecane or a brominated aromatic crosslinked polymer, preferably the brominated polystyrene; the halogen-free fire retardant includes but is not only limited to one or more of a nitrogen-containing fire retardant, a phosphorus-containing fire retardant or a nitrogen- and phosphorus-containing fire retardant, preferably the phosphorus-containing fire retardant, and a content of the phosphorus-containing fire retardant is 10 wt %-30 wt % based on the total weight of the polyamide composition.

A polyamide composition containing the halogen-based fire retardant may further contain the flame-retardant aid, whereby a polyamide composition having a more excellent flame retardance may be obtained.

The light stabilizer includes but is not only limited to one or more of a group consisting of phenolic stabilizers, phosphite stabilizers, hindered amine stabilizers, triazine stabilizers, a sulfur-containing stabilizer, an aniline oxalate series, an aromatic primary amine series and an inorganic phosphorus-containing stabilizer.

According to the polyamide composition of the present invention, various molding products may be prepared by using a well-known molding method, for example, compression molding, injection molding, gas-assisted injection molding, sinter molding, extrusion molding, blow molding, film molding, hollow molding, multilayer molding and melt spinning and the like.

A use of the above-described polyamide composition in a molding decorative lamp. Compared with the prior art, the present invention has the following advantageous effects:

the polyamide composition, prepared by adopting the polyamide resin having a specific pH value and a specific relative viscosity and adding the metal element of a specific content of the present invention, can be applied to a molding decorative lamp, and compared with a flame-retardant polypropylene material of an existing molding decorative lamp, can significantly improve a coloring property, a color stability and a heat retention stability of the material; and the molding decorative lamp is good in a durability, bright in colors, and high in production yield.

### DETAILED DESCRIPTION OF THE INVENTION

Now, raw materials used in Examples and Comparative Examples will be described as follows, but are not limited to these materials:

fire retardants used:

| | Manufacturing | |
|---|---|---|
| Type | Enterprise | Brand |
| nitrogen-based | commercially | MCA |
| fire retardant | available | |
| phosphorus-based | commercially | RDP |
| fire retardant | available | |
| phosphorus-based | commercially | OP1230 |
| fire retardant | available | |

antioxidants used:

| | Manufacturing | |
|---|---|---|
| Type | Enterprise | Model |
| N,N′-bis-(3-(3,5-di-tert-butyl-4- | BASF | 1098 |
| hydroxylphenyl) propionyl) hexane diamine | | |
| triethylene glycol | BASF | 245 |
| ether-di(3-tert-butyl-4-hydroxyl-5- | | |
| methylphenyl) propionate | | |
| Pentaerythritol tetra[β-(3,5-di- | BASF | 1010 |
| tert-butyl-4-hydroxylphenyl) propionate] | | |
| tri[2.4-di-tert-butylphenyl] phosphite | BASF | 168 |
| phosphite | BASF | P-EPQ |

sourceful metal compounds of metal elements used:

| | Manufacturing | |
|---|---|---|
| Type | Enterprise | Model |
| calcium | commercially | calcium carbonate, calcium oxide, |
| compound | available | calcium stearate, calcium hydroxide |
| magnesium | commercially | magnesium oxide, magnesium hydroxide, |
| compound | available | stearate magnesium |
| iron | commercially | iron oxide, iron hydroxide, iron |
| compound | available | carbonate |
| aluminium | commercially | aluminium oxide, aluminium magnesium |
| compound | available | salt, aluminium hydroxide, aluminium |
| | | potassium sulfate |
| sodium | commercially | sodium oxide, sodium peroxide, sodium |
| compound | available | carbonate, sodium bicarbonate |
| nickel | commercially | nickel titanate |
| compound | available | |
| the bismuth | commercially | bismuth vanadate |
| compound | available | |
| copper | commercially | copper oxide |
| compound | available | |
| zinc | commercially | zinc oxide |
| compound | available | |

Testing methods for various properties:

(1) determination of pH of a polyamide resin: taking 0.5000 g of the polyamide resin, adding 50 ml of a phenol, cooling to room temperature after heating to reflux, and determining its pH value by using a nonaqueous electrode.

(2) a testing method for a relative viscosity of the polyamide resin: referring to GB12006.1-89, a polyamide viscosity number determination method; a specific testing method is as follows: testing a relative viscosity ηr of the polyamide having a concentration of 10 mg/ml in a 98% concentrated sulfuric acid at 25±0.01° C.;

(3) testing of a tinting strength: adding a certain amount of colorant, sampling to test colors L, a, and b and comparing with a standard sample, and then calculating:

ΔE=(ΔL²+Δa²+Δb²)^{1/2}; the tinting strength is good: ΔE ≦0.3; the tinting strength is poor: ΔE >0.3.

(4) a tensile strength: determining in accordance with ISO 527-2, measuring conditions are 23° C. and 50 mm/min.

(5) a tensile strength (a heat retention): determining in accordance with ISO 527-2, measuring conditions are 23° C. and 50 mm/min. Wherein, a sample bar for injection molding is a testing result of the sample bar obtained by injection molding of a material staying in a cavity of an injection molding machine for 20 min.

(6) a tensile strength retention rate: the tensile strength retention rate−the tensile strength (the heat retention)/the tensile strength×100%.

(7) testing for a flame retardance: in accordance with the UL94 standard, the thicknesses of the measuring sample bars are 0.75 mm and 0.3 mm, wherein the 0.3 mm sample bar needs to be machined.

(8) characterization of a color stability: continually producing polyamide compositions of Comparative Examples and Examples for 6 hours, sampling every other 2 h to test colors L, a, and b, and then calculating a color difference ΔE=(ΔL²+Δa²+Δb²)^{1/2};

a judging criterion, the color is stable: oEs of the samples measured for three times are all less than or equal to 0.5; the color is instable: one of ΔEs of the samples measured for three times is greater than 0.5.

The polyamide resins used in the present invention are as follows, and molar ratios of each unit in the resins are listed:

PA1: 10/106=50/50, the relative viscosity 2.243, pH=2.8;

PA2: 10/106/10C=50/48/2, the relative viscosity 2.261, pH=3.2;

PA3: 66/6=50/50, the relative viscosity 2.261, pH=3.6;

PA4: 6/66/10/106=48/32/12/8, the relative viscosity 2.263, pH=4.1;

PA5: 6/66/12/126=40/32/20/8, the relative viscosity 2.366, pH=7.0;

PA6: 6/66/12/126/6C/12C=10/40/32/10/2/6, the relative viscosity 3.133, pH=4.0;

PA7: 10/106=50/50, the relative viscosity 2.243, pH=8; and

PA8: 6/66/10/106=48/32/12/8, the relative viscosity 2.231, pH=9.3, wherein C represents 1,4-cyclohexane dicarboxylic acid.

A preparation method of the polyamide resin used in the present invention is as follows:

reaction raw materials are added in an autoclave in proportion, and sodium hypophosphite, benzoic acid and a deionized water are further added; a weight of the sodium hypophosphite is 0.1%-0.5% of a weight of the introduced materials other than the deionized water, a mount of the benzoic acid substance is 2%-8% of a total amount of the diacid substance, and a weight of the deionized water is 20%-40% of a total weight of the introduced materials. After vacuumizing, a mixed gas of a high-purity nitrogen gas and carbon dioxide is filled in as a shielding gas, the introduced materials are stirred for 3-5 hours when the temperature is raised to 210-230° C., then a valve is opened to decompress and drain, the temperature starts to be raised when an amount of the drained water reaches to 70% of the amount of the introduced deionized water, the temperature is raised to 250-270° C. within 3 hours, and the temperature maintains constant for 2 hours. After completion of the reaction, the products are obtained.

By reasonably adjusting a monomer constitution and a proportion of the mixed gas of the high-purity nitrogen gas and carbon dioxide as the shielding gas in the above-described process, resins having different pH values may be obtained.

### Examples 1-7 and Comparative Examples 1-6

### Preparation of a Polyamide Composition

In accordance with formulas in Table 1, after a polyamide resin, a fire retardant, an antioxidant, and a filler are uniformly mixed in a high-speed mixer, these are added into a double-screw extruder through a main feeding mouth, a sourceful metal compound of the metal element is side-fed by a side feeding scale, and they are extruded, cooled by means of water, pelletized and dried to obtain the polyamide compositions.

Temperatures of respective zones of a screw cylinder in an extruder are as follows: the temperature of the first zone is 180° C., the temperature of the second zone is 240-260° C., the temperature of the third zone is 250-270° C., the temperature of the fourth zone is 250-270° C., the temperature of the fifth zone is 240-260° C., the temperature of the sixth zone is 230-250° C., the temperature of the seventh zone is 220-240° C., the temperature of the eighth zone is 220-240° C., the temperature of the ninth zone is 220-240° C., and the temperature of a machine head is 250-270° C.; a rotational speed of a main engine is 300-400 rpm, and a vacuum degree is -0.08 MPa-0.06 MPa. Then, the material is dried and injected.

TABLE 1
Comparison of properties of the polyamide compositions in Examples 1-7 and
Comparative Examples 1-6

| | | | | | | | | Com- | Com- | Com- | Com- | Com- | Com- |
|---|---|---|---|---|---|---|---|---|---|---|---|---|---|
| | | | | | | | | par- | par- | par- | par- | par- | par- |
| | | | | | | | | ative | ative | ative | ative | ative | ative |
| | Ex- | Ex- | Ex- | Ex- | Ex- | Ex- | Ex- | Ex- | Ex- | Ex- | Ex- | Ex- | Ex- |
| | ample | ample | ample | ample | ample | ample | ample | ample | ample | ample | ample | ample | ample |
| | 1 | 2 | 3 | 4 | 5 | 6 | 7 | 1 | 2 | 3 | 4 | 5 | 6 |
| polyamide | PA1 | PA2 | PA3 | PA4 | PA1 | PA2 | PA2 | PA5 | PA6 | PA7 | PA8 | PA1 | / |
| resin | | | | | | | | | | | | | |
| poly- | 0 | 0 | 0 | 0 | 0 | 0 | 0 | 0 | 0 | 0 | 0 | 0 | 100 |
| propylene | | | | | | | | | | | | | |
| material of | | | | | | | | | | | | | |
| decorative | | | | | | | | | | | | | |
| lamp/part | | | | | | | | | | | | | |
| content of | 80 | 70 | 50 | 50 | 30 | 90 | 99 | 70 | 50 | 80 | 50 | 80.1 | 0 |
| polyamide | | | | | | | | | | | | | |
| resin/part | | | | | | | | | | | | | |
| MCA fire | 5 | 10 | 30 | 30 | 30 | 5 | 0.5 | 10 | 30 | 5 | 30 | 5 | 0 |
| retardant/ | | | | | | | | | | | | | |
| part | | | | | | | | | | | | | |
| antioxidant | 0.5 | 0.5 | 0.5 | 0.5 | 0.5 | 0.5 | 0 | 0.5 | 0.5 | 0.5 | 0.5 | 0.5 | 0 |
| 1010/part | | | | | | | | | | | | | |
| content of | 0.1 | 0 | 0 | 0.005 | 0 | 0 | 0.5 | 0 | 0 | 0.1 | 0.005 | 0 | 0 |
| copper | | | | | | | | | | | | | |
| (copper | | | | | | | | | | | | | |
| elements | | | | | | | | | | | | | |
| derived from | | | | | | | | | | | | | |
| copper | | | | | | | | | | | | | |
| oxide)/part | | | | | | | | | | | | | |
| content of | 0 | 0.2 | 0 | 0 | 1 | 0 | 0 | 0.2 | 0 | 0 | 0 | 0 | 0 |
| nickel | | | | | | | | | | | | | |
| (nickel | | | | | | | | | | | | | |
| elements | | | | | | | | | | | | | |
| derived | | | | | | | | | | | | | |
| from nickel | | | | | | | | | | | | | |
| titanate)/part | | | | | | | | | | | | | |
| content of | 0 | 0 | 0.007 | 0 | 0 | 0.001 | 0 | 0 | 0.007 | 0 | 0 | 0 | 0 |
| iron (iron | | | | | | | | | | | | | |
| elements | | | | | | | | | | | | | |
| derived | | | | | | | | | | | | | |
| from | | | | | | | | | | | | | |
| iron oxide)/ | | | | | | | | | | | | | |
| part | | | | | | | | | | | | | |
| filler/part | 14.4 | 19.3 | 19.493 | 19.495 | 38.5 | 4.499 | 0 | 19.3 | 19.493 | 14.4 | 19.495 | 14.4 | 0 |
| tensile | 83 | 84 | 87 | 83 | 82 | 80 | 79 | 82 | 79 | 82 | 80 | 80 | 28 |
| strength/ | | | | | | | | | | | | | |
| MPa | | | | | | | | | | | | | |
| tensile | 81 | 82 | 86 | 80 | 79 | 73 | 78.8 | 60 | 59 | 65 | 58 | 70 | 25 |
| strength | | | | | | | | | | | | | |
| (heat | | | | | | | | | | | | | |
| retention)/ | | | | | | | | | | | | | |
| MPa | | | | | | | | | | | | | |
| tensile | 97.6 | 97.6 | 98.9 | 96.4 | 96.3 | 91.3 | 99.7 | 73.2 | 74.7 | 79.3 | 72.5 | 87.5 | 89.3 |
| strength | | | | | | | | | | | | | |
| retention | | | | | | | | | | | | | |
| rate/% | | | | | | | | | | | | | |
| UL94 | V-0 | V-0 | V-0 | V-0 | V-0 | V-0 | V-0 | V-0 | V-1 | V-0 | V-0 | V-0 | V-0 |
| (0.75 mm) | | | | | | | | | | | | | |
| UL94 | V-1 | V-0 | V-0 | V-0 | V-0 | V-1 | V-1 | V-2 | V-1 | V-2 | V-2 | V-2 | V-2 |
| (0.3 mm) | | | | | | | | | | | | | |
| tinting | 0.15 | 0.17 | 0.09 | 0.24 | 0.23 | 0.28 | 0.22 | 0.30 | 0.45 | 0.50 | 0.45 | 0.64 | 0.78 |
| strength | | | | | | | | | | | | | |
| color | 0.35 | 0.37 | 0.29 | 0.44 | 0.43 | 0.48 | 0.42 | 0.50 | 0.65 | 0.70 | 0.65 | 0.84 | 0.98 |
| stability | | | | | | | | | | | | | |

It may be seen from Table 1 that, relative to Comparative Examples, because the polyamide resin having the specific pH value and the specific relative viscosity is employed, and the metal element of the specific content is added, the polyamide compositions in Examples vary less in the heat retention tensile strength, remain substantially unchanged in their tensile strength, and have obvious advantages; and their coloring property, color stability, and heat retention stability are all superior; whereas, because pHs and relative viscosities of the polyamide resins employed in Comparative Examples both fall out of a scope claimed by the claims, the obtained polyamide compositions are worse in coloring property, color stability and heat retention stability, and the obtained molding products in the later period of injection molding are poor in properties.

The above-described Examples are preferred embodiments of the present invention, but the embodiments of the present invention are not limited by the above-described Examples, any other changes, modifications, substitutions, combinations, and simplifications made without deviating from the spirits and principles of the present invention should all he equivalent displacement modes, and are all within the protection scope of the present invention.

What is claimed:

1. A polyamide composition, comprising the following components:
a. 30 wt %-99 wt % of a polyamide resin;
b. 0.001 wt %-3 wt % of a metal element; and
c. 0-69.5 wt % of an additive;
a content of the metal element b is preferably 0.005 wt %-1 wt %, more preferably 0.007 wt %-0.2 wt %;
said percentages by weight are all relative to a total weight of a, b, and c.

2. The polyamide composition according to claim 1, wherein,
i) a value of said polyamide resin in a phenol is less than 7;
ii) said polyamide resin is selected from one or more of a unit AB formed of an aliphatic diacid and/or alicyclic diacid A of 4-20 carbon atoms, and an aliphatic diamine and/or alicyclic diamine B of 4-20 carbon atoms; a unit C formed of a lactam C of 4-20 carbon atoms; and a unit ABC formed of the aliphatic diacid and/or alicyclic diacid A of 4-20 carbon atoms, the aliphatic diamine and/or alicyclic diamine B of 4-20 carbon atoms and the lactam C of 4-20 carbon atoms; and
iii) a relative viscosity of said polyamide resin in a 98% concentrated sulfuric acid having a measuring concentration of the polyamide resin of 10 mg/ml is 2-3 at 25° C.

3. The polyamide composition according to claim 2, wherein the pH value of said polyamide resin in the phenol shows: 1 ≦pH ≦6, preferably 2 ≦pH ≦4.

4. The polyamide composition according to claim 2, wherein in said aliphatic diacid and/or alicyclic diacid A of 4-20 carbon atoms, said aliphatic diacid is selected from one or more of succinic acid, glutaric acid, adipic acid, suberic acid, azelaic acid, sebacic acid, undecanedioic acid, dodecanedioic acid, tridecanedioic acid, tetradecanedioic acid, pentadecanedioic acid, hexadecanedioic acid, and octadecanedioic acid; said alicyclic diacid is selected from one or more of dimer acid, cis- and/or trans-cyclohexane-1,4-dicarboxylic acid, and cis- and/or trans-cyclohexane-1,3-dicarboxylic acid (CHDA); in said aliphatic diamine and/or alicyclic diamine B of 4-20 carbon atoms, said aliphatic diamine is selected from one or more of 1,4-butane diamine, 1,5-pentane diamine, 1,6-hexane diamine, 1,8-octane diamine (OMDA), 1,9-nonane diamine (NMDA), 1,10-decane diamine, 2-methyl-1,8-octane diamine (MODA), 2,2,4-trimethyl hexamethylene diamine (TMHMD), 2,4,4-trimethyl hexamethylene diamine (TMHMD), 5-methyl-1,9-nonane diamine, 1,11-undecane diamine, 2-butyl-2-ethyl-1,5-pentane diamine, 1,12-dodecane diamine, 1,13-tridecane diamine, 1,14-tetradecane diamine, 1,16-hexadecane diamine, and 1,18-octadecane diamine; said alicyclic diamine B is selected from one or more of cyclohexane diamine, 1,3-bis(amino-terminated methyl) cyclohexane (BAC), isophorone diamine, norbornane dimethylamine, 4,4′-diamino-terminated dicyclohexyl methane (PACM), 2,2-(4,4′-diamino-terminated dicyclohexyl) propane (PACP), and 3,3′-dimethyl-4,4′-diamino dicyclohexyl methane (MACM); and said lactam C of 4-20 carbon atoms is selected from one or more of caprolactam, undecanolactam, and dodecanolactam.

5. The polyamide composition according to claim 2, wherein said unit AB formed of the aliphatic diacid and/or alicyclic diacid A of 4-20 carbon atoms and the aliphatic diamine and/or alicyclic diamine B of 4-20 carbon atoms is selected from one or more of a polyhexamethylene adipamide PA66, a polyhexamethylene sebacamide PA610, and a polydecamethylene sebacamide PA1010; said unit C formed of the lactam C of 4-20 carbon atoms is selected from one or more of a polycaprolactam PA6, a polyundecanolactam PA11, and a polydodecanolactam PA12; and said unit ABC formed of the aliphatic diacid and/or alicyclic diacid A of 4-20 carbon atoms, the aliphatic diamine and/or alicyclic diamine B of 4-20 carbon atoms and the lactam C of 4-20 carbon atoms is selected from adipic acid-hexane diamine-caprolactam copolymer PA66/6.

6. The polyamide composition according to claim 1, wherein said metal element is derived from a metal compound, said metal compound is selected from one or more of a calcium compound, a magnesium compound, an iron compound, an aluminium compound, a sodium compound, a nickel compound, a bismuth compound, a copper compound, and a zinc compound; said calcium compound is selected from one or more of calcium carbonate, calcium oxide, calcium stearate, and calcium hydroxide; said magnesium compound is selected from one or more of magnesium oxide, magnesium hydroxide, and magnesium stearate; said iron compound is selected from one or more of iron oxide, iron hydroxide, and iron carbonate; said aluminium compound is selected from one or more of aluminium oxide, aluminium magnesium salt, aluminium hydroxide, and aluminium potassium sulfate; said sodium compound is selected from one or more of sodium oxide, sodium peroxide, sodium carbonate, and sodium bicarbonate; the nickel compound is selected from nickel titanate; said bismuth compound is selected from bismuth vanadate; said copper compound is selected from a copper salt, and a complex including copper oxide and copper; and said zinc compound is selected from zinc oxide.

7. The polyamide composition according to claim 1, wherein said metal element preferably contains nickel.

8. The polyamide composition according to claim 1, wherein said additive is selected from one or more of a fire retardant, an antioxidant, a light stabilizer, a heat stabilizer, an impact modifier, a nucleating agent, other polymers, a processing agent, a lubricant, an anti-static agent, a filler, and a colorant.

9. The polyamide composition according to claim 8, wherein said fire retardant is selected from a fire retardant or a composition of the fire retardant and a flame-retardant aid, and its content is 0.5 wt %-30 wt % based on a total weight of the polyamide composition.

10. The polyamide composition according to claim 8, wherein said fire retardant is a halogen-based fire retardant or a halogen-free fire retardant, preferably the halogen-free fire retardant; said halogen-based fire retardant includes but is not only limited to one or more of a brominated polystyrene, a brominated polyphenyl ether, a brominated bisphenol A type epoxy resin, a brominated styrene-maleic anhydride copolymer, a brominated epoxy resin, a brominated phenyoxy resin, decabromodiphenyl ether, decabromodiphenyl, a brominated polycarbonate, perbromotricyclopentadecane or a brominated aromatic crosslinked polymer, preferably the brominated polystyrene; and said halogen-free fire retardant includes but is not only limited to one or more of a nitrogen-containing fire retardant, a phosphorus-containing fire retardant or a nitrogen- and phosphorus-containing fire retardant, preferably the phosphorus-containing fire retardant, and its content is 10 wt %-30 wt % based on the total weight of the polyamide composition.

11. A use of the polyamide composition described according to claim 1 in a molding decorative lamp.

12. The polyamide composition according to claim 4, wherein said unit AB formed of the aliphatic diacid and/or alicyclic diacid A of 4-20 carbon atoms and the aliphatic diamine and/or alicyclic diamine B of 4-20 carbon atoms is selected from one or more of a polyhexamethylene adipamide PA66, a polyhexamethylene sebacamide PA610, and a polydecamethylene sebacamide PA1010; said unit C formed of the lactam C of 4-20 carbon atoms is selected from one or more of a polycaprolactam PA6, a polyundecanolactam PA11, and a polydodecanolactam PA12; and said unit ABC formed of the aliphatic diacid and/or alicyclic diacid A of 4-20 carbon atoms, the aliphatic diamine and/or alicyclic diamine B of 4-20 carbon atoms and the lactam C of 4-20 carbon atoms is selected from adipic acid-hexane diamine-caprolactam copolymer PA66/6.
